(19) United States
(12) Patent Application Publication
(10) Pub. No.: US 2011/0186194 A1
(43) Pub. Date: Aug. 4, 2011

(54) ILLUMINATED BILLHOLDER AND METHOD THEREFOR

(76) Inventors: Gus Gallo, Las Vegas, NV (US); Gloria Lucia Flores, Las Vegas, NV (US)

(21) Appl. No.: 12/700,016

(22) Filed: Feb. 4, 2010

(51) Int. Cl. A45C 1/06; H01K 7/00; A45C 11/18

(52) U.S. Cl. 150/132; 315/76; 150/147

(57) ABSTRACT

A billfold has a front cover. A back cover is connected to the front cover by a spine, the spine allowing the front cover to fold over the back cover. At least one pocket is formed on an interior side of the back cover. A card pocket is formed on an interior side of the back cover. A first lighting element is formed on the exterior side of the front cover wherein the lighting element flush mounted to the exterior side of the front cover. A lighting circuit is coupled to the first lighting element for controlling illumination of the first lighting element. The lighting circuit illuminates the first lighting element when the lighting circuit detects the presence of an object in one of the at least one pocket or the card pocket. A power supply coupled to the lighting circuit and the first lighting element.

### FIELD OF THE INVENTION

This invention relates to a billfold to be used in restaurants to present a customer with a check and to receive payment from the customer, and, more specifically, to a billfold which will illuminate to indicate that payment is in the billfold and is ready to be collected by a restaurant employee.

### BACKGROUND OF THE INVENTION

Many restaurants use a billfold to present a check to a customer and to receive payment. In general, most restaurants will use a foldable billfold wherein the bill is positioned inside the foldable billfold. The foldable billfold generally has one or more pockets for receiving the payment. Billfolds serve as a discrete way of bring a bill to a customer so that others may not be able to see the bill. Billfolds may further serve as notification to the customer that the server will collect the payment at the table, rather than the customer taking the bill to a cash register.

One problem with current restaurant billfolds is that current restaurant billfolds do not have any type of indicator to signal a restaurant employee that the payment is in the billfold and is ready to be collected. In general, the restaurant employee will drop off the bill in the billfold at the customer's table. The restaurant employee will then allow a sufficient amount of time to allow the customer to finish the meal, continue conversations, and so forth. After some time has passed, the server may approach the customer's table to collect the billfold and payment. Unfortunately, many times the restaurant employee will approach the table before the customer has had an opportunity to review the bill and select the proper payment. The premature attempt to collect the bill payment can be embarrassing to the customer as well as the server. The premature attempt to collect the bill payment may further cause the customer to interrupt his meal or conversation to attend to the payment of the bill. Alternatively, the server may have attempted to collect the bill once and been premature. This may lead the server to error on the side of caution and prolong the period of the next attempt thus leading to the customer unnecessarily waiting an extended period of time for the server to collect his payment.

Therefore, a need existed to provide a system and method to overcome the above problem. The system and method will provide a billfold which will illuminate to indicate that payment is in the billfold and is ready to be collected by a restaurant employee.

### SUMMARY OF THE INVENTION

In accordance with one embodiment of the present invention, a billfold is disclosed. The billfold has a front cover. A back cover is connected to the front cover by a spine, the spine allowing the front cover to fold over the back cover. At least one pocket is formed on an interior side of the back cover. A card pocket is formed on an interior side of the back cover. A first lighting element is formed on the exterior side of the front cover wherein the lighting element flush mounted to the exterior side of the front cover. A lighting circuit is coupled to the first lighting element for controlling illumination of the first lighting element. The lighting circuit illuminates the first lighting element when the lighting circuit detects the presence of an object in one of the at least one pocket or the card pocket. A power supply coupled to the lighting circuit and the first lighting element.

The present invention is best understood by reference to the following detailed description when read in conjunction with the accompanying drawings.

### BRIEF DESCRIPTION OF THE DRAWINGS

FIG. 1 is an elevated perspective view of one embodiment of the billfold of the present invention in an open position;

FIG. 2 is an elevated perspective view of the front cover of the billfold in a closed position; and

FIG. 3 a circuit diagram of the lighting circuit used in the billfold of the present invention.

Common reference numerals are used throughout the drawings and detailed description to indicate like elements.

### DETAILED DESCRIPTION

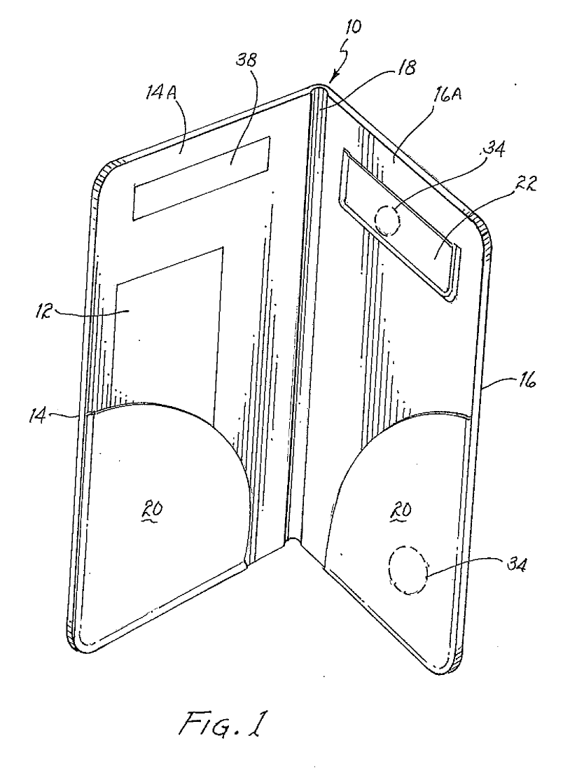

Referring to FIG. 1, a billfold 10 is shown in an open position. The billfold 10 is used for holding a removable restaurant check 12. The billfold 10 includes a front cover 14 and a back cover 16. The front cover 14 is attached to the back cover 16 by a spine 18. The spine 18 allows the front cover 14 and back cover 16 to be folded together. The front cover 14, the back cover 16 and the spine 18 may be made out of leather, plastic, or similar types of material. The listing of the above materials is given as an example and should not be seen in a limiting manner. Other materials may be used without departing from the spirit and scope of the present invention.

The interior surface 14A and 16A of the front and back covers 14 and 16 respectively may have one or more pockets 20. The interior surface 16A of the back cover 16 may further have a card holder 22. In general, the pockets 20 and the card holder will be formed of the same material as the front and back covers 14 and 16 respectively.

Referring now to FIGS. 1-3, the billfold 10 may have an illumination device 24. The illumination device 24 may be used to signal a restaurant employee that payment is in the billfold 10 and is ready to be collected. The illumination device 24 may be comprised of a lighting circuit 26 and a first lighting element 28. The first lighting element 28 may be a light bulb, a Light Emitting Diode (LED), a flexible electroluminescent (EL) sheet that when excited with a voltage at a set frequency will illuminate, or the like. The listing of the above is given as an example and should not be seen in a limiting scope.

The lighting element 28 may be formed on a front surface 14B of the front cover 14. In accordance with one embodiment, the lighting element 28 may be mounted flush with the front surface 14B of the front cover 14. The lighting element 28 may have a covering 29. The covering 29 may have the name of the restaurant, credit card name, etc. Alternatively, if a flexible EL sheet is used as the lighting element 28, the EL sheet may have the name of the restaurant, credit card name, etc. The lighting element 28 may illuminate when payment is in the billfold 10 and is ready to be collected by a restaurant employee.

The lighting element 28 is coupled to the lighting circuit 26. In accordance with one embodiment, the lighting circuit 26 is used to control the illumination of the lighting element 28. The lighting circuit 26 may have a power supply 30. The power supply 30 may be used to power the different components of the lighting circuit 26. In general, the power supply 30 is a low voltage battery.

The lighting circuit 26 may have a processor unit 32. The processor unit 32 is used to control the illumination of the lighting element 28. The processor unit 32 may be used to animate the lighting element 28. For example, the processor unit 32 may animate the lighting element 28 by flashing the lighting element 28, having the lighting element 28 vary in intensity so that the lighting element 28 slowly grows brighter and brighter and then starts to fade to dark and then illuminates again. The processor unit 32 may also be programmed to excite the lighting element 28 in such a way that the lighting element 28 changes color. The listing of the above is only given as an example and should not be seen as to limit the scope of the present invention. The processor unit 32 may be programmed to control the illumination of the lighting element 28 in other manners without departing from the spirit and scope of the present invention.

The lighting circuit 26 will generally have one or more sensor units 34. The sensor units 34 may be coupled to the processor unit 34 if the lighting circuit 26 has a processor unit 34 or directly to the power supply 30. The sensor units 34 are used to activate and deactivate the lighting circuit 26. However, as stated above, the processor 20 may be programmed to animate the lighting element 28. In accordance with one embodiment of the present invention, the sensor units 34 are normally open sensors. Thus the lighting circuit 26 will not illuminate the lighting element 28 until the sensor units 34 are closed.

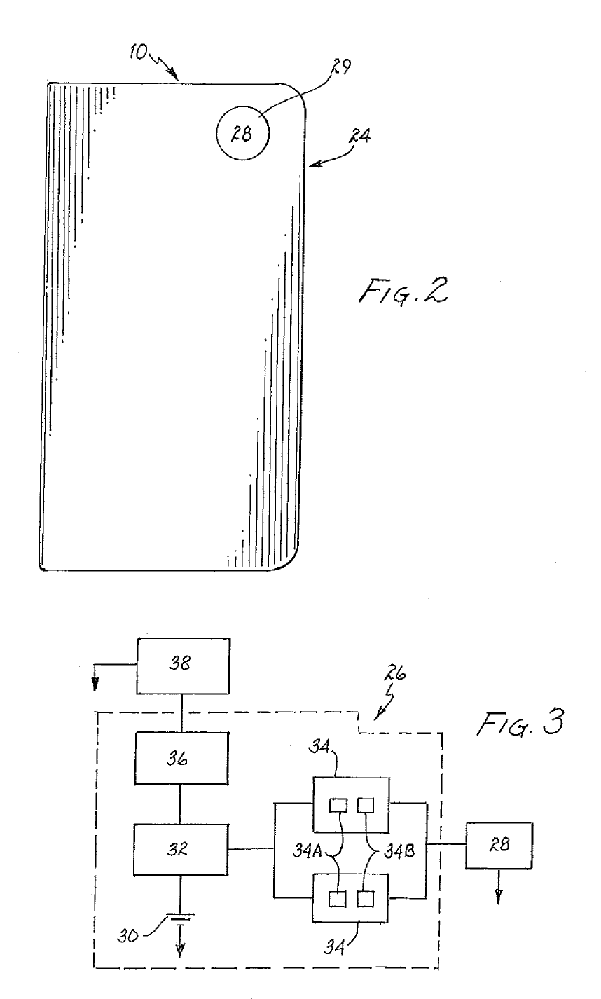

In accordance with one embodiment, a sensor unit 34 is placed in both the pocket 20 formed on the interior surface 16A of the back cover 16 and the card holder 22 also formed on the back cover 16. As shown in FIG. 3, the sensor units 34 may be coupled in a parallel fashion. Each sensor unit 34 will monitor if an object is placed in the respective pocket 20 or card holder 22 the sensor unit 34 is monitoring. If an object is placed in either the pocket 20 or card holder 22 the respective sensor unit 34 will close so the power supply 30 may illuminate the lighting element 28. The sensor unit 34 may be a pressure sensor. Alternatively, the sensor unit 34 may be an infra-red sensor. The infra-red sensor may have a first unit 34A positioned in a front area and a second unit 34B positioned in a rear area of the respective pocket 20 or card holder 22. The first unit 34A may send a signal to be received by the second unit 34B. In general, the signal may be an infra-red beam or the like. If the second unit 34 does not receive the signal, indicating the presence of an item in the respective pocket 20 or card holder 22, the respective sensor unit 34 will close so the power supply 30 may illuminate the lighting element 28.

In accordance with another embodiment of the present invention, the lighting circuit 26 further has a switch 36 located on either the interior surface 14A and 16A of the front and back covers 14 and 16. The switch 36 is coupled to the power supply 18 and to a second lighting element 38. The second lighting element 38 may be a light bulb, a Light Emitting Diode (LED), a flexible electroluminescent (EL) sheet that when excited with a voltage at a set frequency will illuminate, or the like. The listing of the above is given as an example and should not be seen in a limiting scope.

In accordance with one embodiment, when the billfold 10 is opened, the switch 36 is closed to connect the second lighting element 38 to the power supply 18 there by illuminating the second lighting element 38. The second lighting element 38 may aid restaurant patrons in reading the bill by providing additional lighting.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A billfold comprising:
a front cover;
a back cover connected to the front cover by a spine, the spine allowing the front cover to fold over the back cover;
at least one pocket formed on an interior side of the back cover;
a card pocket formed on an interior side of the back cover;
a first lighting element formed on the exterior side of the front cover, the lighting element flush mounted to the exterior side of the front cover;
a lighting circuit coupled to the first lighting element for controlling illumination of the first lighting element, the lighting circuit illuminating the first lighting element when the lighting circuit detects the presence of an object in one of the at least one pocket or the card pocket; and
a power supply coupled to the lighting circuit and the first lighting element.

2. A billfold in accordance with claim 1 wherein the first lighting element is a flexible electroluminescent lighting sheet, the electroluminescent lighting sheet illuminating when excited with a voltage at a set frequency.

3. A billfold in accordance with claim 1 wherein the first lighting element is one of an LED or a flexible electroluminescent lighting sheet.

4. A billfold in accordance with claim 1 wherein the lighting circuit comprises:
a first sensor attached to an interior of that at least one pocket; and
a second sensor coupled in parallel to the first sensor and attached to an interior of the card pocket;
wherein the first lighting element illuminates when one of the first sensor or second sensor detects the presence of an object in one of the at least one pocket or the card pocket.

5. A billfold in accordance with claim 4 wherein the lighting circuit further comprises:
a second lighting element formed on one of the interior of the a front cover or the interior of the back cover; and
a switching device coupled to the second lighting element and to the power supply, wherein opening the billfold closes the switching device causing the second lighting element to illuminate.

6. A billfold in accordance with claim 4 wherein the lighting circuit further comprises a processor unit coupled to the first lighting element, the processor unit controlling animation of the first lighting element.

7. A billfold in accordance with claim 4 wherein both the first sensor and second sensor comprises:
a first unit; and
a second unit receiving a signal from the first unit;
wherein the first sensor closes to illuminate the first lighting element when the signal to the second unit is interrupted.

8. A billfold in accordance with claim 4 wherein the first sensor comprises:
a first unit; and
a second unit receiving a signal from the first unit;
wherein the first sensor closes to illuminate the first lighting element when the signal to the second unit is interrupted.

9. A billfold in accordance with claim 4 wherein the second sensor comprises:
a first unit; and
a second unit receiving a signal from the first unit;
wherein the first sensor closes to illuminate the first lighting element when the signal to the second unit is interrupted.

10. A billfold comprising:
a front cover having exterior and interior surfaces;
a back cover having exterior and interior surfaces and connected to the front cover by a spine, the spine allowing the front cover to fold over the back cover;
a first pocket formed on the interior surface of the back cover;
a card pocket formed on the interior surface of the back cover;
a first lighting element formed on the exterior surface of the front cover, the lighting element flush mounted to the exterior surface of the front cover;
a second lighting element formed in one of the interior surfaces of the front cover or back cover;
a lighting circuit coupled to the first lighting element and second lighting element for controlling illumination of the first lighting element and second lighting element, the lighting circuit illuminating the first lighting element when the lighting circuit detects the presence of an object in one of the first pocket or the card pocket and illuminating the second lighting element when the front cover is separated from the back cover; and
a power supply coupled to the lighting circuit and the first lighting element and second lighting element.

11. A billfold in accordance with claim 10 wherein the first lighting element is a flexible electroluminescent lighting sheet, the electroluminescent lighting sheet illuminating when excited with a voltage at a set frequency.

12. A billfold in accordance with claim 10 wherein the first lighting element is one of an LED or a flexible electroluminescent lighting sheet.

13. A billfold in accordance with claim 10 wherein the lighting circuit comprises:
a first sensor attached to an interior of the first pocket; and
a second sensor coupled in parallel to the first sensor and attached to an interior of the card pocket;
wherein the first lighting element illuminates when one of the first sensor or second sensor detects the presence of an object in one of the at least one pocket or the card pocket.

14. A billfold in accordance with claim 13 wherein the lighting circuit further comprises a switching device coupled to the second lighting element and to the power supply, wherein opening the billfold closes the switching device causing the second lighting element to illuminate.

15. A billfold in accordance with claim 13 wherein the lighting circuit further comprises a processor unit coupled to the first lighting element, the processor unit controlling animation of the first lighting element.

16. A billfold in accordance with claim 13 wherein both the first sensor and second sensor comprises:
a first unit; and
a second unit receiving a signal from the first unit;
wherein the first sensor closes to illuminate the first lighting element when the signal to the second unit is interrupted.

17. A billfold comprising:
a front cover having exterior and interior surfaces;
a back cover having exterior and interior surfaces and connected to the front cover by a spine, the spine allowing the front cover to fold over the back cover;
a first pocket formed on the interior surface of the back cover;
a card pocket formed on the interior surface of the back cover;
a first lighting element formed on the exterior surface of the front cover, the lighting element flush mounted to the exterior surface of the front cover;
a second lighting element formed in one of the interior surfaces of the front cover or back cover;
a lighting circuit coupled to the first lighting element and second lighting element for controlling illumination of the first lighting element and second lighting element, the lighting circuit illuminating the first lighting element when the lighting circuit detects the presence of an object in one of the first pocket or the card pocket and illuminating the second lighting element when the front cover is separated from the back cover; and
a power supply coupled to the lighting circuit and the first lighting element and second lighting element;
wherein the lighting circuit comprises:
a first sensor attached to an interior of the first pocket;
a second sensor coupled in parallel to the first sensor and attached to an interior of the card pocket;
wherein the first lighting element illuminates when one of the first sensor or second sensor detects the presence of an object in one of the at least one pocket or the card pocket; and
a switching device coupled to the second lighting element and to the power supply, wherein opening the billfold closes the switching device causing the second lighting element to illuminate.

18. A billfold in accordance with claim 17 wherein the first lighting element is one of an LED or a flexible electroluminescent lighting sheet.

19. A billfold in accordance with claim 17 wherein the lighting circuit further comprises a processor unit coupled to the first lighting element, the processor unit controlling animation of the first lighting element.

20. A billfold in accordance with claim 17 wherein both the first sensor and second sensor comprises:
a first unit; and
a second unit receiving a signal from the first unit;
wherein the first sensor closes to illuminate the first lighting element when the signal to the second unit is interrupted.
